(19) United States
(12) Patent Application Publication
(10) Pub. No.: US 2023/0373251 A1
(43) Pub. Date: Nov. 23, 2023

(54) MINI RIM TIRE

(71) Applicant: COMPAGNIE GENERALE DES ETABLISSEMENTS MICHELIN, Clermont-Ferrand (FR)

(72) Inventors: SYLVIE DUCHEMIN, Clermont-Ferrand (FR); BRUNO GUIMARD, Clermont-Ferrand (FR); PIERRE MOUREAU, Clermont-Ferrand (FR)

(21) Appl. No.: 18/030,661

(22) PCT Filed: Oct. 7, 2021
(86) PCT No.: PCT/FR2021/051746

§ 371 Date: Apr. 6, 2023

(30) Foreign Application Priority Data
Oct. 9, 2020 (FR) 2010355
Oct. 9, 2020 (FR) 2010356
Oct. 9, 2020 (FR) 2010359

(51) Int. Cl. B60C 9/28; B60C 3/04

(52) U.S. Cl. CPC B60C 9/28; B60C 3/04; B60C 2200/04

(57) ABSTRACT

The tire (11) for a passenger vehicle comprises an axially narrowest working layer (26), the axially narrowest working layer (26) having an axial width T2 expressed in mm. The tire is adapted to be mounted (10) on a mounting support (100) comprising a rim (200) having a rim width A expressed in mm and a rim width code according to the ETRTO 2019 Standards Manual. The tire (11) has a load index L1 such that LI≥LI′+1, LI′ being the load index of an EXTRA LOAD tire of the same size according to the ETRTO 2019 Standards Manual. The ratio T2/A is such that T2/A≤1.00. The rim width code is equal to the measuring rim width code for the tire size minus 0.5.

The present invention relates to a tyre. A tyre is understood to mean a casing intended to form a cavity in collaboration with a mounting support, this cavity being adapted to be pressurized to a pressure higher than atmospheric pressure. A tyre according to the invention has a structure of substantially toroidal shape exhibiting symmetry of revolution about a main axis of the tyre.

The development of electric or hybrid passenger vehicles has seen an increase in the weight of vehicles, in particular on account of the batteries, which have a relatively high weight substantially proportional to the range of the vehicles. Thus, for example, to increase the range of an electric vehicle, it is necessary to increase the size of the batteries and therefore the weight of the vehicle.

Simply put, it is estimated today that one kilometer of range for an electric motor increases the weight of the vehicle by one kilogram. Thus, in order to achieve a range of 500 kilometers, it is necessary to increase the weight of a combustion engine vehicle by around 500 kg. In order to equip such vehicles, it is necessary to use tyres capable of carrying a very heavy load.

A tyre for a passenger vehicle is known from the prior art, this tyre being capable of carrying a relatively heavy load. This tyre is marketed under the MICHELIN™ brand in the Pilot Sport 4 range and is 255/35R18 in size. This tyre has an EXTRA LOAD (abbreviated to XL) version as defined by the ETRTO 2019 Standards Manual and, in this EXTRA LOAD version, has a load index equal to 94. This means that, at a pressure of 290 kPa, the tyre is capable of carrying a load of 670 kg. This load-bearing capacity is relatively high compared to a tyre of the same size and designated as STANDARD LOAD (abbreviated to SL), having a load index equal to 90 and capable of carrying a load of 600 kg at a pressure of 250 kPa.

For such a tyre to be placed on the market, it must pass regulatory tests. For example, in Europe, the tyre must pass the load/speed performance test described in Annex VII of UNECE Regulation No 30.

Nevertheless, in its EXTRA LOAD version, and even more so in its STANDARD LOAD version, such a tyre is not capable of carrying the extra load corresponding to the batteries that are necessary to achieve the desired range. Thus, tyre manufacturers have had to offer new solutions to meet this new need.

One solution considered by tyre manufacturers is, for a given vehicle, the use of tyres of larger size, which would make it possible to carry a heavier load. Thus, a given vehicle could be fitted with tyres having a higher load index. For example, a vehicle fitted with the tyres described above in their EXTRA LOAD version could be fitted with size 275/35R19 tyres in their EXTRA LOAD version having a load index equal to 100 and capable, at a pressure of 290 kPa, of carrying a load of 800 kg, much greater than the load of 670 kg.

On the one hand, such an increase in the size of the tyres necessarily entails either a reduction in the interior space of the vehicle or an enlargement of the exterior bulk of the vehicle, neither of which is desirable for reasons of roominess and compactness of the vehicle.

On the other hand, such an increase in the size of the tyres entails a redesign of the vehicle chassis, which for obvious reasons of cost is not desirable either.

Lastly, such an increase in the size of the tyres, in particular the nominal section width, leads to an increase in the external noise generated by the tyre as well as an increase in the rolling resistance, which is also not desirable in the interests of reducing noise pollution and the energy consumption of the vehicle.

Thus, another solution considered by tyre manufacturers is, for a given size and a given version of a tyre, to increase its inflation pressure. This is because the higher the pressure, the more the tyre is capable of carrying a heavy load.

Nevertheless, the use of a relatively high pressure stiffens the tyre at the expense of comfort for the passengers of the vehicle, which is obviously not desired by some motor vehicle manufacturers in cases where the comfort of the passengers takes priority over the load that can be carried.

Another problem encountered by manufacturers during the development of a tyre is the dissipation of energy and the temperature in the structure, which can be identified in particular in the test described in Annex VII of UNECE Regulation No 30. To be specific, on increasing the load applied to a tyre so as to simulate the addition of a weight corresponding to the batteries necessary to obtain the desired autonomy, a significant increase in the dissipation of energy and a temperature rise both in the bead and in the shoulder of the tyre have been observed.

The aim of the invention is to provide a tyre capable of carrying a heavier load than existing tyres without necessarily involving an increase in tyre pressure, while controlling the dissipation of energy and the rise in temperature in the structure of the tyre without sacrificing the roominess, compactness and comfort of the vehicle.

Thus, the invention relates to a tyre for a passenger vehicle comprising a crown, two beads, two sidewalls each connecting each bead to the crown, and a carcass reinforcement anchored in each bead, the crown comprising a crown reinforcement and a tread, the carcass reinforcement extending in each sidewall and in the crown radially internally to the crown reinforcement, the crown reinforcement being arranged radially between the tread and the carcass reinforcement and comprising a working reinforcement comprising at least an axially narrowest working layer, the axially narrowest working layer having an axial width T2 expressed in mm, the tyre being adapted to be mounted on a mounting support comprising a rim, the tyre having a load index LI such that LI≥LI′+1, LI′ being the load index of an EXTRA LOAD tyre of the same size according to the ETRTO 2019 Standards Manual, and when the tyre is mounted on a rim having a rim width code equal to the measuring rim width code for the tyre size defined according to the ETRTO 2019 Standards Manual minus 0.5, the ratio T2/A is such that T2/A≤1.00 with A being the rim width A according to the ETRTO 2019 Standards Manual, expressed in mm of the rim.

According to the invention, the tyre is a tyre for a passenger vehicle. Such a tyre is for example defined in the ETRTO (European Tyre and Rim Technical Organisation) 2019 Standards Manual. Such a tyre generally has, on at least one of the sidewalls, a marking in accordance with the marking in the ETRTO 2019 Standards Manual indicating the size of the tyre in the form X/Y αV∪β, with X designating the nominal section width, Y designating the nominal aspect ratio, α designating the structure and being R or ZR, V designating the nominal rim diameter, U designating the load index and β designating the speed rating

The load index LI′ is the load index of a tyre of the same size, i.e. having the same nominal section width, the same nominal aspect ratio, the same structure (R and ZR being considered identical) and the same nominal rim diameter. The load index LI′ is given in the ETRTO 2019 Standards Manual, specifically in the part entitled Passenger Car Tyres—Tyres with Metric Designation, pages 20 to 41.

The axial width of the axially narrowest working layer is measured on a tyre section in a meridian plane and corresponds to the width in the axial direction between the two axial ends of the working layer.

By increasing the load index of the tyre of the invention relative to the load index of a tyre of the same size in its EXTRA LOAD version, the invention makes it possible to increase the load-bearing capacity of the mounted assembly comprising the tyre according to the invention and the mounting support without however modifying the roominess, compactness and comfort of the vehicle on which it is used. To be specific, as the size of the tyre according to the invention is identical to that of the tyre in its EXTRA LOAD version, the tyre does not take up any more space than the tyre in its EXTRA LOAD version. A tyre according to the invention may bear a distinctive marking making it possible to distinguish it from its STANDARD LOAD version and from its EXTRA LOAD version, for example a marking such as HL (for HIGH LOAD) or XL+ (for EXTRA LOAD+). Such a marking is disclosed in particular in the ETRTO 2021 Standards Manual, page 3 of the section General Notes—Passenger Car Tyres, to designate HIGH LOAD CAPACITY tyres. Examples of sizes are also disclosed in the ETRTO 2021 Standards Manual, page 44, paragraph 9.1 in the section Passenger Car Tyres—Tyres with Metric Designation.

Nevertheless, in order to control energy dissipation and the temperature in the structure during operation of the tyre according to the invention, it is necessary to ensure that the axial width of the axially narrowest working layer has the correct size in relation to the width of the rim. To be specific, the inventors responsible for the invention discovered that, in the case of a heavy load beyond that known in the prior art, the deflection of the tyre, that is to say the difference between the radius of the mounted assembly under no load and the radius of the mounted assembly under that load, was greatly increased. This increase in deflection leads to relatively high energy dissipation and rise in temperature in the tyre structure, particularly in the bead.

In order to control this, the invention proposes straightening the sidewall of the tyre, that is to say making the sidewall straighter in the radial direction, with the aim of increasing the radial stiffness of the tyre to prevent excessive flexion of the tyre and increased energy dissipation and temperature in the tyre structure. The invention recommends reducing the ratio T2/A to a value of less than or equal to 1.00 so as:
for a given rim width A, to reduce the axial width T2 of the axially narrowest working layer, which leads to a reduction in the width of the contact patch and therefore radial straightening of the sidewall of the tyre,
for an axial width T2 of the given axially narrowest working layer, to increase the rim width A, which also leads to radial straightening of the sidewall of the tyre.

If a person skilled in the art changes the axial width T2 of the axially narrowest working layer, they will adapt the characteristics of the crown of the tyre, in particular those of the crown reinforcement comprising the working reinforcement and any hoop reinforcement, and those of the tread, as a function of the axial width T2 they have determined.

In both cases, the radial stiffness of the tyre is increased, and therefore the deflection of the tyre is reduced for a given load, which makes it possible to at least partially offset the impact of the increase in the load, and the stresses exerted on the structure of the tyre are thus reduced, as are therefore the energy dissipation and the rise in temperature during operation of the tyre.

In order to limit the increase in the masses in rotation on the vehicle but also to reduce the space taken up by the mounted assembly to the benefit of roominess and compactness of the vehicle, preference will be given to reducing the axial width T2 of the axially narrowest working layer rather than increasing the rim width A. Thus, the invention requires that the rim have a rim width code equal to the measuring rim width code for the tyre size minus 0.5. This limits the increase in the masses in rotation on the vehicle but also the space taken up by the mounted assembly to the benefit of roominess and compactness of the vehicle. Lastly, by virtue of the ratio T2/A, the risk of the tyre being mounted on a rim having a rim width that would be too small and that would cause relatively high flexion of the tyre is reduced.

The measuring rim is defined in particular on pages 20 to 41 of the part Passenger Car Tyres—Tyres with Metric Designation of the ETRTO 2019 Standards Manual.

The tyre according to the invention has substantially the shape of a torus about an axis of revolution substantially coincident with the axis of rotation of the tyre. This axis of revolution defines three directions conventionally used by a person skilled in the art: an axial direction, a circumferential direction and a radial direction.

The axial direction is understood to be the direction substantially parallel to the axis of revolution of the tyre or of the mounted assembly, that is to say the axis of rotation of the tyre or of the mounted assembly.

The circumferential direction is understood to be the direction that is substantially perpendicular both to the axial direction and to a radius of the tyre or of the mounted assembly (in other words, tangent to a circle centered on the axis of rotation of the tyre or of the mounted assembly).

The radial direction is understood to be the direction along a radius of the tyre or of the mounted assembly, that is to say any direction that intersects the axis of rotation of the tyre or of the mounted assembly and is substantially perpendicular to that axis.

The median plane of the tyre (denoted M) is understood to be the plane perpendicular to the axis of rotation of the tyre which is situated axially mid-way between the two beads and passes through the axial middle of the crown reinforcement.

The equatorial circumferential plane of the tyre is understood to be, in a meridian section plane, the plane passing through the equator of the tyre, perpendicular to the median plane and to the radial direction. The equator of the tyre is, in a meridian section plane (plane perpendicular to the circumferential direction and parallel to the radial and axial directions), the axis that is parallel to the axis of rotation of the tyre and located equidistantly between the radially outermost point of the tread that is intended to be in contact with the ground and the radially innermost point of the tyre that is intended to be in contact with a support, for example a rim.

The meridian plane is understood to be a plane parallel to and containing the axis of rotation of the tyre or of the mounted assembly and perpendicular to the circumferential direction.

Radially inner and radially outer are understood to mean closer to the axis of rotation of the tyre and further away from the axis of rotation of the tyre, respectively. Axially inner and axially outer are understood to mean closer to the median plane of the tyre and further away from the median plane of the tyre, respectively.

A bead is understood to be the portion of the tyre intended to enable the tyre to be attached to a mounting support, for example a wheel comprising a rim. Thus, each bead is notably intended to be in contact with a flange of the rim allowing it to be attached.

Any range of values denoted by the expression “between a and b” represents the range of values extending from more than a to less than b (that is to say excluding the end-points a and b), whereas any range of values denoted by the expression “from a to b” means the range of values extending from a up to b (that is to say including the strict end-points a and b).

In one advantageous embodiment, LI′+1≤LI≤LI′+4, preferably LI′+2≤LI≤LI′+4. Thus, the load-bearing capacity of the tyre is increased further.

In further advantageous embodiments, 0.85≤T2/A, preferably 0.90≤T2/A, and more preferentially 0.93≤T2/A≤0.97.

It is preferable to have a ratio T2/A that is not too low. To be specific, for a given rim width A, it is preferable to not excessively reduce the value of the axial width T2 of the axially narrowest working layer, as this risks reducing the edgewise bending stiffness and therefore the cornering stiffness when there is a high amount of cornering. Moreover, when the value of the axial width T2 of the axially narrowest working layer is reduced too much, the width of the contact patch is reduced, which increases the pressure exerted on the tread and therefore wear, this wear being amplified by the fact that the tyres according to the invention are intended to carry relatively heavy loads necessarily leading to high wear, in any case higher than tyres of the same size in their EXTRA LOAD version which are required to carry lighter loads. For an axial width T2 of the given axially narrowest working layer, it is also preferable not to increase the value of the rim width A too much in order, as explained above, to limit the increase in the masses in rotation on the vehicle but also to reduce the space taken up by the mounted assembly to the benefit of roominess and compactness of the vehicle.

In preferred embodiments, the tyre has a nominal section width SW such that T2≥SW−75, preferably T2≤SW−70. For a given nominal section width, the axially narrowest working layer which primarily defines the width of the contact patch is not too narrow. As explained above, this makes it possible to maintain good tyre wear performance despite the fact that the tyres according to the invention are intended to carry relatively heavy loads necessarily leading to relatively high wear.

In preferred embodiments, the tyre has a nominal section width SW such that T2≤SW−27, preferably T2≤SW−30.

In these embodiments, as in the invention in general, the nominal section width is that indicated by the size marking inscribed on the sidewall of the tyre.

In preferred embodiments, the tyre has a nominal section width SW ranging from 205 to 315, a nominal aspect ratio ranging from 25 to 55, a nominal rim diameter ranging from 17 to 23 and a load index LI ranging from 98 to 116, preferably a nominal section width SW ranging from 225 to 315, a nominal aspect ratio ranging from 25 to 55, a nominal rim diameter ranging from 18 to 23 and a load index LI ranging from 98 to 116, and more preferentially a nominal section width SW ranging from 245 to 315, a nominal aspect ratio ranging from 30 to 45, a nominal rim diameter ranging from 18 to 23 and a load index LI ranging from 98 to 116. As explained above, the tyres according to the invention are intended to carry relatively heavy loads necessarily leading to relatively high wear compared to tyres of the same sizes in their EXTRA LOAD version. Thus, it is particularly advantageous to use tyres which have a relatively large nominal section width in order to reduce the pressure exerted on the tread and therefore the wear.

Advantageously, 0.82≤H/LI≤0.98. Thus, the invention is preferably applied to tyres likely to have relatively significant deflection because they have a relatively high load index for a given sidewall height, that is to say satisfying H/LI≤0.98. This is made possible by the ratio T2/A which reduces energy dissipation despite significant sidewall deflection. However, if the sidewall is too short in relation to the load index, i.e. satisfying H/LI<0.82, the flexion of the sidewall leads to relatively high compression of the carcass reinforcement and therefore an increase in energy dissipation.

Particularly preferred embodiments are those in which the tyre has a size and a load index LI chosen from among the following sizes and load indexes: 225/55R18 105, 225/55ZR18 105,205/55R19 100, 205/55ZR19 100, 235/45R21 104, 235/45ZR21 104, 285/45R22 116, 285/45ZR22 116, 205/40R17 88, 205/40ZR17 88, 245/40R19 101, 245/40ZR19 101, 255/40R20 104, 255/40ZR20 104, 245/40R21 103, 245/40ZR21 103, 255/40R21 105, 255/40ZR21 105, 265/40R21 108, 265/40ZR21 108, 255/40R22 106, 255/40ZR22 106, 255/35R18 98, 255/35ZR18 98, 245/35R20 98, 245/35ZR20 98, 265/35R20 102, 265/35ZR20 102, 245/35R21 99, 245/35ZR21 99, 255/35R21 101, 255/35ZR21 101, 265/35R21 103, 265/35ZR21 103, 275/35R21 105, 275/35ZR21 105, 285/35R21 108, 285/35ZR21 108, 295/35R22 111, 295/35ZR22 111, 275/35R23 108, 275/35ZR23 108, 285/30R21 103, 285/30ZR21 103, 315/30R21 109, 315/30ZR21 109, 325/30R21 111, 325/30ZR21 111, 315/30R23 111, 315/30ZR23 111.

Advantageously, when the tyre is mounted on the mounting support, the tyre is inflated to a pressure ranging from 200 to 350 kPa, preferably from 250 to 330 kPa. The pressure is that of the mounted assembly at 25° C. without the tyre having been run. It often corresponds to one of the inflation pressures recommended by motor vehicle manufacturers.

For uses in which it is desired to prioritize the load-bearing capacity of the tyre, a relatively high pressure, greater than or equal to 270 kPa, will be used.

For uses in which it is desired to prioritize the comfort of the passengers and the behavior of the vehicle, in particular the grip on dry ground, a relatively low pressure, less than or equal to 270 kPa, will be used.

In some embodiments, the working reinforcement comprises a radially inner working layer and a radially outer working layer arranged radially on the outside of the radially inner working layer.

Preferably, the axially narrowest working layer is the radially outer working layer of the working reinforcement.

In some embodiments, the axially narrowest working layer or each working layer is delimited axially by two axial edges of said working layer and comprises working filamentary reinforcing elements extending axially from one axial edge to the other axial edge of said working layer substantially parallel to one another.

Optionally, each working filamentary reinforcing element extends in a main direction forming an angle which, in terms of absolute value, is strictly greater than 10°, preferably ranging from 15° to 50° and more preferentially ranging from 20° to 35°, with the circumferential direction of the tyre.

Preferably, in the embodiments in which the working reinforcement comprises a radially innermost working layer and a radially outermost working layer arranged radially on the outside of the radially innermost layer, the main direction in which each working filamentary reinforcing element of the radially innermost working layer extends and the main direction in which each working filamentary reinforcing element of the radially outermost working layer extends form oppositely oriented angles with the circumferential direction of the tyre.

In embodiments in which the tyre has a carcass referred to as radial, the carcass reinforcement comprises at least one carcass layer, the or each carcass layer being delimited axially by two axial edges of the or each carcass layer, the or each carcass layer comprises carcass filamentary reinforcing elements extending axially from one axial edge to the other axial edge of the or each carcass layer.

In some alternative forms, the or each carcass layer comprises textile carcass filamentary reinforcing elements extending axially from one axial edge to the other axial edge of the or each carcass layer in a main direction forming an angle which, in terms of absolute value, ranges from 80° to 90°, with the circumferential direction of the tyre.

Filamentary element is given to mean an element exhibiting a length at least 10 times greater than the greatest dimension of its cross-section, regardless of the shape of the latter: circular, elliptical, oblong, polygonal, in particular rectangular or square or oval. In the case of a rectangular cross-section, the filamentary element takes the form of a strip.

Textile is understood to mean a filamentary element comprising one or more textile elementary monofilaments optionally coated with one or more layers of a coating based on an adhesive composition. This or these textile elementary monofilaments is or are obtained, for example, by melt spinning, solution spinning or gel spinning. Each textile elementary monofilament is made from an organic material, in particular a polymeric material, or an inorganic material, for example glass or carbon. The polymeric materials may be of the thermoplastic type, for instance aliphatic polyamides, notably polyamides 6,6, and polyesters, notably polyethylene terephthalate. The polymeric materials may be of the non-thermoplastic type, such as for example aromatic polyamides, in particular aramid, and cellulose, either natural or artificial, in particular rayon.

In a first embodiment, the carcass reinforcement comprises a single carcass layer.

Such a carcass reinforcement makes it possible to obtain a tyre with optimal energy dissipation and operating temperature, in particular under heavy load and under a pressure less than or equal to the recommended pressure for a tyre of the same size in its STANDARD LOAD or EXTRA LOAD version. To be specific, unlike a carcass reinforcement comprising two carcass layers in which the flexion of each sidewall causes relatively high compression of the axially innermost carcass layer in the sidewall and at the shoulder of the tyre and increased energy dissipation, the single carcass layer exhibits less compression in the sidewall and at the shoulder and therefore leads to a lower and more optimal operating temperature.

In particular, it is advantageous to control this operating temperature in cases of under-inflation which are frequently and chronically encountered. To be specific, it is known that under-inflation leads to an increase in the operating temperature of the sidewalls in the case of tyres in their STANDARD LOAD or EXTRA LOAD version. In the case of a HIGH LOAD CAPACITY tyre, under-inflation is even more problematic and leads to an amplified increase in the operating temperature of the sidewalls owing to the very heavy load carried by the tyre.

Single carcass layer is understood to mean that, apart from the carcass layer, the carcass reinforcement does not have any layer reinforced by filamentary reinforcing elements. The filamentary reinforcing elements of such reinforced layers excluded from the carcass reinforcement of the tyre comprise metal filamentary reinforcing elements and textile filamentary reinforcing elements. Very preferably, the carcass reinforcement is made up of the single carcass layer.

In this first embodiment, optionally, the tyre has a sidewall height H defined by H=SW×AR/100 with SW the nominal section width and AR the nominal aspect ratio of the tyre and such that H<95.

Tyres with a relatively low sidewall height have relatively high compression of the carcass reinforcement, especially when the load carried is heavy, which is the case of tyres with a load index LI in accordance with the invention. Thus, it is very advantageous to use a single carcass layer in combination with a sidewall height H<95.

In certain optional but nevertheless advantageous embodiments, 90≤H<95. To be specific, these embodiments have relatively high sidewalls in the range of sidewall heights covered by the first embodiment, for which the use of a single carcass layer is particularly advantageous because it makes it possible to significantly reduce the weight of the tyre and the rolling resistance compared to a tyre comprising two carcass layers.

In a first alternative form allowing anchoring of the carcass reinforcement by turning up, the single carcass layer forms a winding around a circumferential reinforcing element of each bead such that an axially inner portion of the single carcass layer is arranged axially on the inside of an axially outer portion of the single carcass layer and such that each axial end of the single carcass layer is arranged radially on the outside of each circumferential reinforcing element.

In a second alternative form allowing anchoring of the carcass reinforcement without turning up, the single carcass layer has a portion arranged axially between two circumferential reinforcing elements of each bead and each axial end of the single carcass layer is arranged radially on the inside of each radially outer end of each circumferential reinforcing element of each bead. Such an alternative form of anchoring of the carcass reinforcement is described for example in documents WO2005/113259 or WO2021/123522.

The anchoring of the carcass reinforcement will be chosen in particular as a function of the sidewall height H and the index LI. To be specific, the lower the sidewall height H and the higher the load index, the more preference will be given to the second alternative form of anchoring. In cases where the sidewall height H is high and the load index low, the first or the second alternative form of anchoring may be chosen indiscriminately.

In the first embodiment, each textile carcass filamentary reinforcing element preferably comprises an assembly of at least two multifilament plies having a total count greater than or equal to 475 tex.

To be specific, so that the single carcass layer has sufficient mechanical strength, use will be made of textile carcass filamentary reinforcing elements with a relatively high count, which, for a given material, makes it possible to achieve relatively high mechanical strength.

Optionally in the first embodiment, each textile carcass filamentary reinforcing element has an average diameter D≥0.85 mm, preferably D≥0.90 mm. Also optionally, D≤1.10 mm, preferably D≤1.00 mm.

In the first embodiment and for the reasons explained above, even more advantageously 0.82≤H/LI≤0.92.

In a second embodiment, the carcass reinforcement comprises first and second carcass layers.

Such a carcass reinforcement makes it possible to obtain a reinforcement which is relatively resistant to pinch shock in particular.

In this second embodiment, optionally, the tyre has a sidewall height H defined by H=SW×AR/100 with SW the nominal section width and AR the nominal aspect ratio of the tyre and such that H≥95, preferably H≥100.

Tyres having a relatively high sidewall height lead to relatively high tensioning of the carcass reinforcement, in particular of the portion of the carcass reinforcement anchored in the bead, for example by turning up around a circumferential reinforcing element such as a bead wire, this being due to the relatively large volume of inflation gas that they contain in comparison with a tyre having a relatively low sidewall height. This tensioning is all the greater the heavier the load carried, which is the case of tyres having a load index LI in accordance with the invention. Thus, it is very advantageous to use two carcass layers, which makes it possible to significantly reduce the tensioning of each carcass layer.

Moreover, unlike the tyres according to the first embodiment, tyres with a relatively high sidewall height have relatively low compression of the carcass reinforcement. The risk of premature deterioration of the carcass reinforcement, in particular under heavy load and under relatively low pressure, is therefore averted despite the presence of two carcass layers.

Preferably, each first and second carcass layer extends in each sidewall and in the crown radially on the inside of the crown reinforcement.

In a preferred alternative form, one of the first and second carcass layers forms a winding around a circumferential reinforcing element of each bead such that an axially inner portion of said carcass layer is arranged axially on the inside of an axially outer portion of said carcass layer and such that each axial end of said carcass layer is arranged radially on the outside of each circumferential reinforcing element.

In a first preferred configuration compatible with the presence of a first and a second carcass layer:
the first carcass layer forms a winding around a circumferential reinforcing element of each bead such that an axially inner portion of the first carcass layer is arranged axially on the inside of an axially outer portion of the first carcass layer and such that each axial end of the first carcass layer is arranged radially on the outside of each circumferential reinforcing element, and
each axial end of the second carcass layer is arranged radially on the inside of each axial end of the first layer and is arranged:
   axially between the axially inner and outer portions of the first carcass layer, or
   axially on the inside of the axially inner portion of the first carcass layer,
   and preferably, each axial end of the second carcass layer is arranged axially between the axially inner and outer portions of the first carcass layer.

Such an arrangement of the first and second carcass layers makes it possible to obtain effective mechanical coupling between the first and second carcass layers, making it possible to reduce the shear stresses between the first and the second carcass layers. Thus, the energy dissipation and the rise in temperature of the tyre are reduced, all the more so as the shear stresses are particularly high under heavy loads.

Indeed, such an arrangement of the carcass reinforcement is particularly advantageous in the case where 95≤H≤155. To be specific, by limiting the sidewall height of the tyre to sidewall heights H such that 95≤H≤155, the volume of gas is reduced and therefore the tensioning of the carcass reinforcement is reduced to a reasonable level.

Moreover, by virtue of the particular arrangement of the first and second carcass layers, surprisingly, what is obtained is a tyre with optimum energy dissipation and an optimum operating temperature in the sidewall, in particular under heavy load and at a pressure less than or equal to the recommended pressure for a tyre of the same size in its STANDARD LOAD or EXTRA LOAD version. This is all the more surprising since the particular arrangement of the first and second carcass layers is located in one area of the tyre, in this case in the bead or close to the bead, but makes it possible to reduce the energy dissipation in another area of the tyre, away from the bead, in this case the sidewall. It has been discovered that the particular arrangement of the carcass reinforcement, that is to say the fact that each axial end of the second carcass layer is arranged axially between the axially inner and outer portions of the first carcass layer, or axially on the inside of the axially inner portion of the first carcass layer, makes it possible to reduce the difference in tension between the first carcass layer and the second carcass layer. And the smaller the difference in tension between the first and second carcass layers, the less shear stress is generated between these first and second carcass layers and the less energy is dissipated.

In a second configuration compatible with the presence of a first and a second carcass layer, the first carcass layer forms a winding around a circumferential reinforcing element of each bead such that an axially inner portion of the first carcass layer is arranged axially on the inside of an axially outer portion of the first carcass layer and such that each axial end of the first carcass layer is arranged radially on the outside of each circumferential reinforcing element, and each axial end of the second carcass layer is arranged radially on the inside of each axial end of the first layer and is arranged axially on the outside of each axially outer portion of the first carcass layer.

This second configuration is particularly advantageous in the case where H>155. To be specific, for HIGH LOAD CAPACITY tyres having a very high sidewall height such that H>155, since the tension at the end of the first carcass layer becomes very high, a carcass reinforcement should be considered in which, unlike the arrangement described in the first configuration, each axial end of the second carcass layer is arranged axially on the outside of each axially outer portion of the first carcass layer. With such an arrangement of the carcass reinforcement, the tension at the end of the first carcass layer will be reduced to a reasonable level.

For HIGH LOAD CAPACITY tyres having a very high sidewall height, that is to say with H>155, even though the difference in tension between the first carcass layer and the second carcass layer remains significant, the sidewall height makes it possible to have a relatively large shear area which dissipates energy effectively and for which it is not preferable to have the arrangement of the first and second carcass layers described in the first configuration.

In the second embodiment, each textile carcass filamentary reinforcing element preferably comprises an assembly of at least two multifilament plies having a total count less than or equal to 475 tex.

Indeed, the presence of two carcass layers makes it possible to reduce the total count of each textile carcass filamentary reinforcing element of each layer, while having a carcass reinforcement of sufficient mechanical strength.

Optionally in the second embodiment, each textile carcass filamentary reinforcing element of each first and second carcass layer respectively has an average diameter D1, D2 such that D1≤0.90 mm and D2≤0.90 mm, preferably D1≤0.85 mm and D2≤0.85 mm and more preferentially D1≤0.75 mm and D2≤0.75 mm.

Such relatively small diameters D1 and D2 make it possible to limit the start of cracking near the end of each first and second carcass layer. This is because the end of each textile carcass filamentary reinforcing element constitutes a point where cracks are more likely to start, in particular due to the fact that it is devoid of any adhesive composition and therefore has little adhesion to the adjacent matrix. in which it is immersed. Reducing each diameter D1, D2 reduces the surface area of the end and therefore the risk of cracks starting. Also optionally, D1 and D2 are such that D1≥0.55 mm and D2≥0.55 mm, preferably D1≥0.60 mm and D2≥0.60 mm.

In the second embodiment and for the reasons explained above, even more advantageously 0.88≤H/LI≤0.98.

Whether in the first or the second embodiment, the nominal section width SW and the nominal aspect ratio AR are those indicated by the size marking inscribed on the sidewall of the tyre and conforming to the ETRTO 2019 Standards Manual. The counts (or linear density) of each ply and filamentary reinforcing element are determined in accordance with the 2014 standard ASTM D≥885/D 885M-10a. The count is given in tex (weight in grams of 1000 m of product—as a reminder: 0.111 tex is equal to 1 denier).

Whether in the first or the second embodiment, the diameter of each textile carcass filamentary reinforcing element is the diameter of the smallest circle in which the textile carcass filamentary reinforcing element is circumscribed. The average diameter is the average of the diameters of the textile carcass filamentary reinforcing elements located over a length of 10 cm of each carcass layer.

Whether in the first or the second embodiment, optionally, each multifilament ply is chosen from a polyester multifilament ply, an aromatic polyamide multifilament ply and an aliphatic polyamide multifilament ply, preferably each multifilament ply is chosen from a polyester multifilament ply and an aromatic polyamide multifilament ply.

Polyester multifilament ply is understood to mean a multifilament ply consisting of monofilaments of linear macromolecules formed of groups linked together by ester bonds. Polyesters are produced by polycondensation by esterification between a dicarboxylic acid, or one of the derivatives thereof, and a diol. For example, polyethylene terephthalate can be manufactured by polycondensation of terephthalic acid and ethylene glycol. Among the known polyesters, mention may be made of polyethylene terephthalate (PET), polyethylene naphthalate (PEN), polybutylene terephthalate (PBT), polybutylene naphthalate (PBN), polypropylene terephthalate (PPT) or polypropylene naphthalate (PPN).

Aromatic polyamide multifilament ply is understood to mean a multifilament ply consisting of monofilaments of linear macromolecules formed of aromatic groups linked together by amide bonds at least 85% of which are directly linked to two aromatic rings, and more particularly of fibers of poly(p-phenylene terephthalamide) (or PPTA), manufactured for a very long time from optically anisotropic spinning compositions. Among the aromatic polyamides, mention may be made of polyarylamides (or PAA, notably known by the Solvay company trade name Ixef), poly(metaxylylene adipamide), polyphthalamides (or PPA, notably known by the Solvay company trade name Amodel), amorphous semiaromatic polyamides (or PA 6-3T, notably known by the Evonik company trade name Trogamid), or para-aramids (or poly(paraphenylene terephthalamide or PA PPD-T notably known by the Du Pont de Nemours company trade name Kevlar or the Teijin company trade name Twaron).

Aliphatic polyamide multifilament ply is understood to mean a multifilament ply consisting of monofilaments of linear macromolecules of polymers or copolymers containing amide functions which do not have aromatic rings and which can be synthesized by polycondensation between a carboxylic acid and an amine. Among the aliphatic polyamides, mention may be made of nylons PA4.6, PA6, PA6.6 or PA6.10, and in particular Zytel from the company DuPont, Technyl from the company Solvay or Rilsamid from the company Arkema.

Very preferably, the assembly is chosen from an assembly of two polyester multifilament plies and an assembly of a polyester multifilament ply and an aromatic polyamide multifilament ply.

Whether in the first or the second embodiment, in certain preferred configurations, each axial end of the wound carcass layer is arranged radially on the inside of the equator of the tyre and even more preferentially arranged at a radial distance of less than or equal to 30 mm from a radially inner end of each circumferential reinforcing element of each bead.

By arranging each axial end of the wound carcass layer inside the equator of the tyre, the mass of the carcass reinforcement is significantly reduced. Furthermore, the vast majority of rims that are currently used for tyres for passenger vehicles have J-type flanges with a height which, in all cases, is less than 30 mm. The greatly preferred arrangement of each axial end in a region corresponding radially substantially to the rim flange makes it possible to mechanically protect each axial end. Specifically, if each axial end were arranged radially too far above each circumferential reinforcing element of each bead, that is to say at a radial distance strictly greater than 30 mm from the radially inner end of each circumferential reinforcing element, each axial end would then be in a flexible region of the tyre that is subjected to excessive stresses, stresses which are particularly high in the case of a HIGH LOAD CAPACITY tyre.

Optionally, the crown reinforcement comprises a hoop reinforcement delimited axially by two axial edges of the hoop reinforcement and comprising at least one hooping filamentary reinforcing element wound circumferentially in a helix so as to extend axially between the axial edges of the hoop reinforcement.

Preferably, the hoop reinforcement is arranged radially on the outside of the working reinforcement.

Preferably, the or each hooping filamentary reinforcing element extends in a main direction forming an angle which, in terms of absolute value, is less than or equal than 10°, preferably less than or equal to 7° and more preferentially less than or equal to 5°, with the circumferential direction of the tyre.

The invention will be understood better on reading the following description, which is given purely by way of non-limiting example and with reference to the drawings, in which:

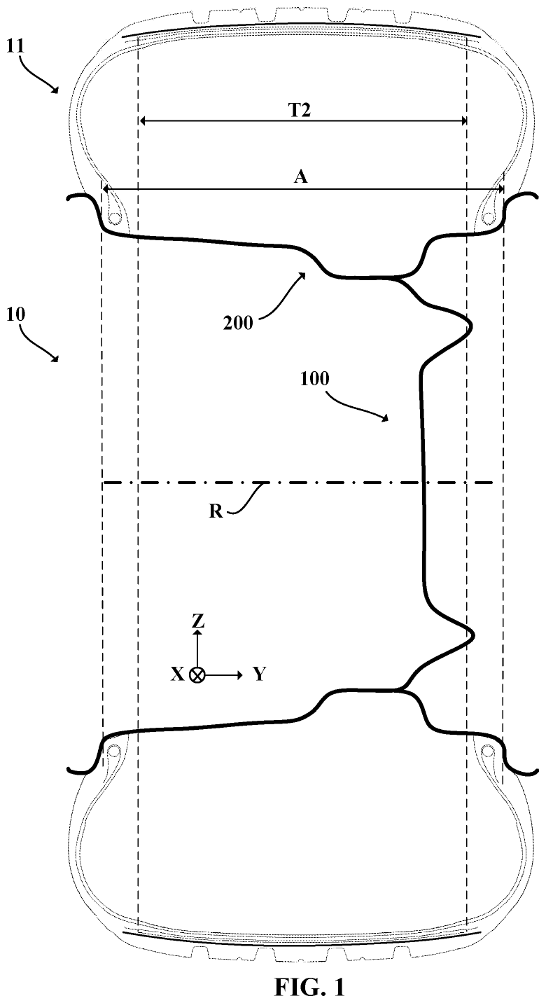

FIG. 1 is a view, in a meridian section plane, of a mounted assembly comprising a tyre according to a first embodiment of the invention,

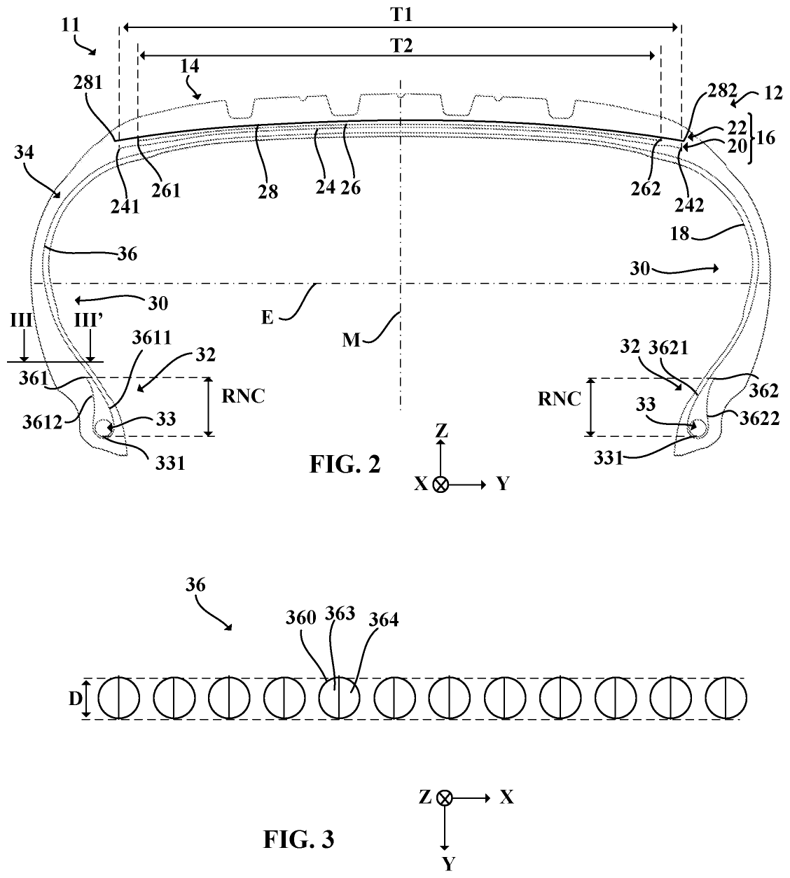

FIG. 2 is a view, in a meridian section plane, of the tyre of FIG. 1,

FIG. 3 is a view in section on the plane III-III′ of FIG. 2 showing the carcass reinforcement of the tyre of FIG. 1,

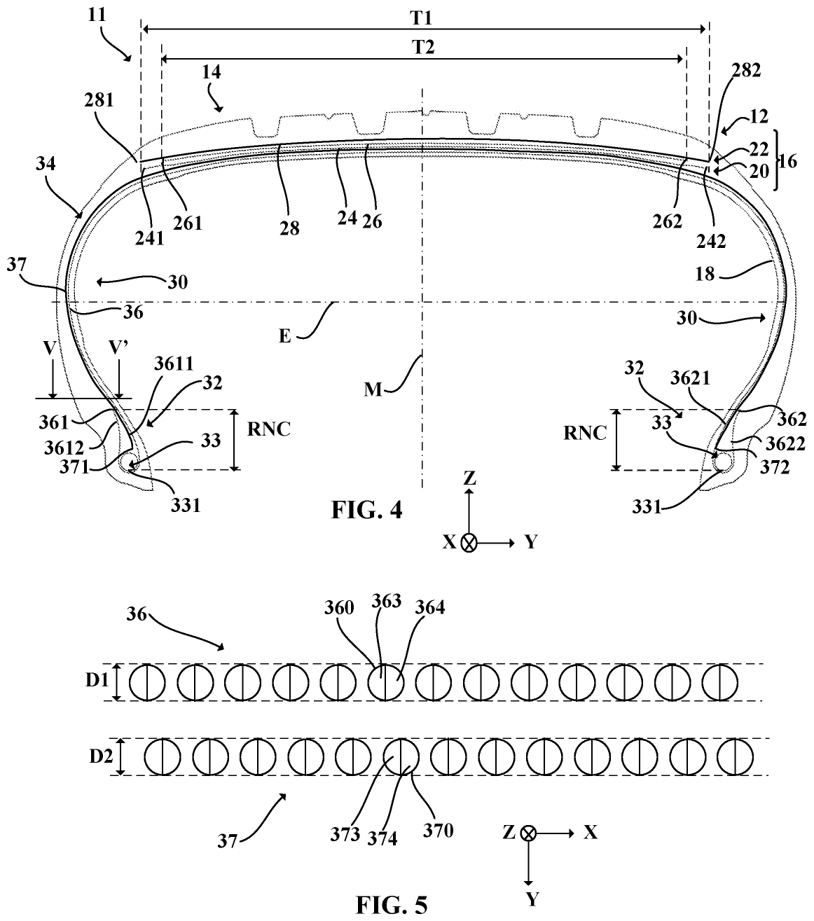

FIGS. 4 and 5 are views similar to FIGS. 2 and 3, respectively, of a tyre according to a second embodiment, and

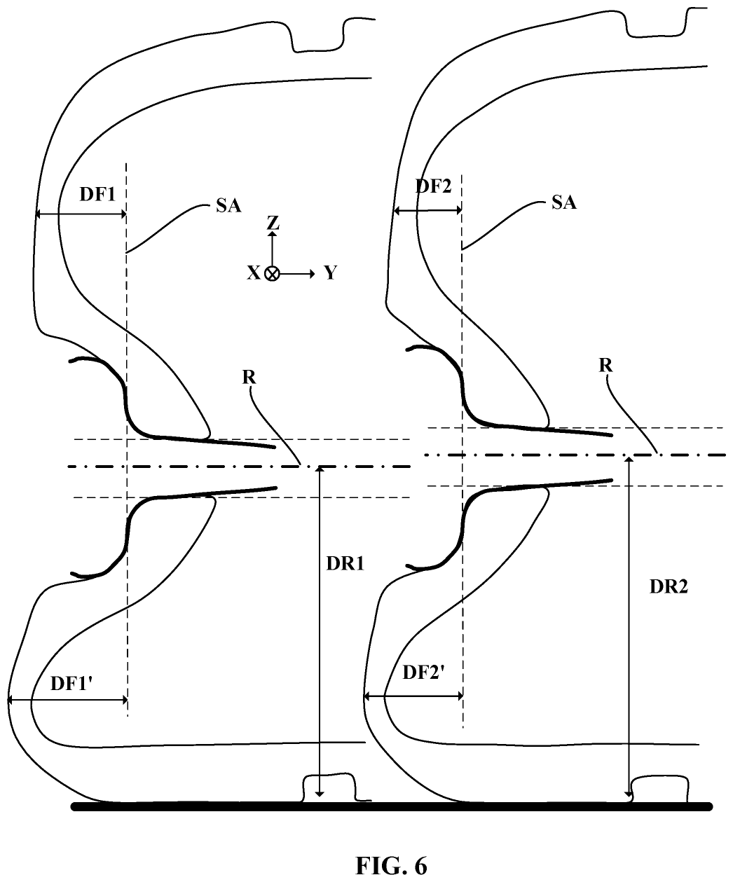

FIG. 6 is a view similar to that of FIG. 1 comparing the deflection of a mounted assembly of the prior art and the deflection of the mounted assembly of FIG. 1.

A frame of reference X, Y, Z corresponding to the usual axial (Y), radial (Z) and circumferential (X) directions, respectively, of a tyre or a mounted assembly is shown in the figures.

In the following description, the measurements taken are taken on an unladen and non-inflated tyre or on a section of a tyre in a meridian plane.

### Tyre According to a First Embodiment

FIG. 1 shows a mounted assembly denoted by the general reference 10. The mounted assembly 10 comprises a tyre 11 according to the invention and a mounting support 100 comprising a rim 200. The tyre 11 is in this case inflated to a pressure ranging from 200 to 350 kPa, preferably from 250 to 330 kPa and in this case equal to 270 kPa.

The tyre 11 has a substantially toric shape about an axis of revolution R substantially parallel to the axial direction Y. The tyre 11 is intended for a passenger vehicle. In the various figures, the tyre 11 is depicted as new, which is to say when it has not yet been run.

The tyre 11 comprises two sidewalls 30 bearing a marking indicating the size of the tyre 11, as well as a speed index and a speed code. In the case at hand, the tyre 11 has a nominal section width SW ranging from 205 to 315, preferably from 225 to 315, more preferentially ranging from 245 to 315 and here equal to 205. The tyre 11 also has a nominal aspect ratio AR ranging from 25 to 55, preferably ranging from 30 to 45, and here equal to 40. The tyre 11 has a nominal rim diameter ranging from 17 to 23, and here equal to 17. The tyre 11 therefore has a sidewall height H defined by SW×AR/100=82<95.

In accordance with the invention, the marking also comprises a load index LI ranging from 98 to 116, such that LI≥LI′+1 with LI′ being the load index of an EXTRA LOAD tyre of the same size according to the ETRTO 2019 Standards Manual. Preferably, LI′+1≤LI≤LI′+4, and even LI′+2≤LI≤LI′+4.

A tyre of size 205/40R17 in its EXTRA LOAD version has a load index equal to 84 as indicated on page 34 of the part Passenger Car Tyres—Tyres with Metric Designation of the ETRTO 2019 Standards Manual. Thus, the load index LI of the tyre 11 is such that LI≥85, preferably 85≤LI≤88 and even 86≤LI≤88 and in this case LI=88. This load index equal to 88 corresponds to the load index of a HIGH LOAD CAPACITY tyre of size 205/40R17. Thus, the tyre 11 is indeed of the HIGH LOAD CAPACITY type.

The tyre 11 is such that 0.82≤H/LI≤0.98 and in this case H/LI=0.93.

For such a size, the ETRTO 2019 Standards Manual indicates, on page 34 of the part Passenger Car Tyres—Tyres with Metric Designation, a measuring rim with a rim width code equal to 7.5. The tyre is adapted to be mounted on the rim 200 of the mounted assembly 10.

In this case, the rim 200 is the rim having a rim width code equal to the measuring rim width code for the tyre size minus 0.5 and therefore here equal to 7.0. The rim 200 has a profile of type J and a rim width A according to the ETRTO 2019 Standards Manual. In the case at hand, the profile of the rim 200 being of type 7.0 J, its rim width A expressed in mm is equal to 177.80 mm.

With reference to FIG. 2, the tyre 11 comprises a crown 12 comprising a tread 14 intended to come into contact with the ground when it is running and a crown reinforcement 16 extending in the crown 12 in the circumferential direction X. The tyre 11 also comprises a layer 18 that is airtight with respect to an inflation gas and is intended to delimit an internal cavity closed with the mounting support 100 for the tyre 11 once the tyre 11 has been mounted on the mounting support 100.

The crown reinforcement 16 comprises a working reinforcement 20 and a hoop reinforcement 22. The working reinforcement 16 comprises at least one working layer and in this case comprises two working layers comprising a radially inner working layer 24 arranged radially on the inside of a radially outer working layer 26. Of the two radially inner 24 and radially outer 26 layers, the axially narrowest layer is the radially outer layer 26.

The hoop reinforcement 22 comprises at least one hooping layer and in this case comprises one hooping layer 28.

The crown reinforcement 16 is surmounted radially by the tread 14. In this case, the hoop reinforcement 22, in this case the hooping layer 28, is arranged radially on the outside of the working reinforcement 20 and is therefore interposed radially between the working reinforcement 20 and the tread 14.

The two sidewalls 30 extend the crown 12 radially inwards. The tyre 11 also has two beads 32 radially on the inside of the sidewalls 30. Each sidewall 30 connects each bead 32 to the crown 12.

The tyre 11 comprises a carcass reinforcement 34 that is anchored in each bead 32 and, in this instance, forms a winding around a circumferential reinforcing element 33, in this case a bead wire. The carcass reinforcement 34 extends radially in each sidewall 30 and axially in the crown 12, radially on the inside of the crown reinforcement 16. The crown reinforcement 16 is arranged radially between the tread 14 and the carcass reinforcement 34. The carcass reinforcement 34 comprises at least one carcass layer 36 and in this case a single carcass layer 36.

The hoop reinforcement 22, in this case the hooping layer 28, is delimited axially by two axial edges 281, 282 and comprises one or more hooping filamentary reinforcing elements that are wound circumferentially helically between each axial edge 281, 282 in a main direction forming an angle AF which, in terms of absolute value, is less than or equal to 10°, preferably less than or equal to 7° and more preferentially less than or equal to 5° with the circumferential direction X of the tyre 10. In this case, AF=−5°.

Each radially inner 24 and radially outer 26 working layer is delimited axially by two axial edges 241, 242, 261, 262, respectively, of each working layer 24, 26. The radially inner working layer 24 has an axial width T1=180.00 mm and the radially outer working layer 26 has an axial width T2=166.00 mm, making the radially outer working layer 26 the axially narrowest working layer.

Note that SW=205 and T2=166 satisfy the following relations T2≥SW−75, preferably T2≥SW−70 and T2≤SW−27, preferably T2≤SW−30.

As shown in FIG. 1, the tyre 11 has radially straightened sidewalls. To be specific, the ratio T2/A is such that 0.85≤T2/A≤1.00, preferably 0.90≤T2/A≤1.00, and more preferentially 0.93≤T2/A≤0.97 and in this case T2/A=0.93.

Each working layer 24, 26 comprises working filamentary reinforcing elements extending axially from one axial edge 241, 261 to the other axial edge 242, 262 of each working layer 24, 26 substantially parallel to one another in main directions forming oppositely oriented angles AT1 and AT2, respectively, which, in terms of absolute value, are strictly greater than 10°, preferably ranging from 15° to 50° and more preferentially ranging from 20° to 35° with the circumferential direction X of the tyre 10. In this case, AT1=−26° and AT2=+26°.

The single carcass layer 36 is delimited axially by two axial edges 361, 362, respectively, and comprises textile carcass filamentary reinforcing elements 360 extending axially from one axial edge 361 to the other axial edge 362 in a main direction D3 forming an angle AC which, in terms of absolute value, ranges from 80° to 90° with the circumferential direction X of the tyre 10; in this case AC=+90°.

The single carcass layer 36 forms a winding around each circumferential reinforcing element 33 of each bead 32 such that an axially inner portion 3611, 3621 of the first carcass layer 36 is arranged axially on the inside of an axially outer portion 3612, 3622 of the first carcass layer 36 and such that each axial end 361, 362 of the first carcass layer 36 is arranged radially on the outside of each circumferential reinforcing element 33.

Each axial end 361, 362 of the single carcass layer 36 is arranged radially on the inside of the equator E of the tyre. More specifically, each axial end 361, 362 of the first carcass layer 36 is arranged at a radial distance RNC of less than or equal to 30 mm from a radially outer end 331 of each circumferential reinforcing element 33 of each bead 32. In this case, RNC=23 mm.

Each working layer 24, 26, hooping layer 28 and carcass layer 36 comprises a matrix for calendering the filamentary reinforcing elements of the corresponding layer. Preferably, the calendering matrix is polymeric and more preferentially elastomeric like those usually used in the field of tyres.

Each hooping filamentary reinforcing element conventionally comprises two multifilament plies, each multifilament ply being made up of a spun yarn of aliphatic polyamide, in this instance nylon, monofilaments, with a count equal to 140 tex, these two multifilament plies being twisted in a helix individually at 250 turns per meter in one direction and then twisted together in a helix at 250 turns per meter in the opposite direction. These two multifilament plies are wound in a helix around one another. As an alternative, use could be made of a hooping filamentary reinforcing element comprising one multifilament ply made up of a spun yarn of aliphatic polyamide, in this case nylon, monofilaments with a count equal to 140 tex, and one multifilament ply made up of a spun yarn of aromatic polyamide, in this case aramid, monofilaments with a count equal to 167 tex, these two multifilament plies being twisted in a helix individually at 290 turns per meter in one direction and then twisted together in a helix at 290 turns per meter in the opposite direction. These two multifilament plies are wound in a helix around one another. As another alternative, use could be made of a hooping filamentary reinforcing element comprising two multifilament plies, each made up of a spun yarn of aromatic polyamide, in this case aramid, monofilaments with a count equal to 330 tex, and one multifilament ply made up of a spun yarn of aliphatic polyamide, in this case nylon, monofilaments with a count equal to 188 tex, each of the multifilament plies being twisted in a helix individually at 270 turns per meter in one direction and then twisted together in a helix at 270 turns per meter in the opposite direction. These three multifilament plies are wound in a helix around one another.

In general, the use of a heavy load leads to a reduction in the acceptable speed limit of the tyre as well as a deterioration in its behavior, for example its cornering stiffness. Thus, by using one or more high-modulus hooping filamentary reinforcing elements, for example like those described in the last two alternatives above comprising one or more aromatic polyamide plies, it is possible to increase the acceptable speed limit for the tyre and improve the behavior, in particular its cornering stiffness.

Each working filamentary reinforcing element is an assembly 4.26 of four steel monofilaments comprising an inner layer of two monofilaments and an outer layer of two monofilaments wound together in a helix around the inner layer at a pitch of 14.0 mm, for example in the direction S. Such an assembly 4.26 has a force at break equal to 640 N, a diameter equal to 0.7 mm. Each steel monofilament has a diameter equal to 0.26 mm and a mechanical strength equal to 3250 MPa. As an alternative, use could also be made of an assembly of six steel monofilaments having a diameter equal to 0.23 mm, comprising an inner layer of two monofilaments wound together in a helix at a pitch of 12.5 mm in a first direction, for example the direction Z, and an outer layer of four monofilaments wound together in a helix around the inner layer at a pitch of 12.5 mm in a second direction, opposite to the first direction, for example the direction S.

As shown in FIG. 3, each textile carcass filamentary reinforcing element 360 comprises an assembly of at least two multifilament plies 363, 364. Each multifilament ply 363, 364 is selected from a polyester multifilament ply, an aromatic polyamide multifilament ply and an aliphatic polyamide multifilament ply, preferably selected from a polyester multifilament ply and an aromatic polyamide multifilament ply. In the case at hand, the assembly is selected from an assembly of two polyester multifilament plies and an assembly of a polyester multifilament ply and an aromatic polyamide multifilament ply, and in this case is made up of two PET multifilament plies, these two multifilament plies being twisted in a helix individually at 270 turns per meter in one direction and then twisted together in a helix at 270 turns per meter in the opposite direction. Each of these multifilament plies has a count equal to 334 tex such that the total count of the assembly is greater than or equal to 475 tex and in this case equal to 668 tex. Each textile carcass filamentary reinforcing element 360 has an average diameter D, expressed in mm, such that D≥0.85 mm, preferably D≥0.90 mm and such that D≤1.10 mm, preferably D≤1.00 mm. In this case, D=0.95 mm.

### Tyre According to a Second Embodiment

A tyre according to a second embodiment will now be described with reference to FIGS. 4 and 5. Elements similar to those of the first embodiment are denoted by identical references.

Unlike the first embodiment, the tyre 11 has the size 255/40R20, that is to say a nominal section width SW=255, a nominal aspect ratio AR=40 and a nominal rim diameter in this case equal to 20. The tyre 11 of the second embodiment has a sidewall height H defined by SW×AR/100=102 95, preferably H≥100.

The marking also comprises a load index LI ranging from 98 to 116, such that LI≥LI′+1 with LI′ being the load index of an EXTRA LOAD tyre of the same size according to the ETRTO 2019 Standards Manual. Preferably, LI′+1≤LI≤LI′+4, and even LI′+2 LI≤LI′+4.

A tyre of size 255/40R20 in its EXTRA LOAD version has a load index equal to 101 as indicated on page 34 of the part Passenger Car Tyres—Tyres with Metric Designation of the ETRTO 2019 Standards Manual. Thus, the load index LI of the tyre 11 is such that LI≥102, preferably 102≤LI≤105 and even 103≤LI≤105 and in this case LI=104. This load index equal to 104 corresponds to the load index of a HIGH LOAD CAPACITY tyre of size 255/40R20 as indicated in the ETRTO 2021 manual. Thus, the tyre 11 is indeed of the HIGH LOAD CAPACITY type.

The tyre 11 is therefore such that 0.82≤H/LI≤0.98 and preferably 0.88≤H/LI≤0.98, and in this case H/LI=0.98.

For such a size, the ETRTO 2019 Standards Manual indicates, on page 34 of the part Passenger Car Tyres—Tyres with Metric Designation, a measuring rim with a rim width code equal to 9. Thus, use will be made of a rim 200 having a rim width code equal to the measuring rim width code for the tyre size minus 0.5, in this case 8.5, that is to say having a rim width A=215.90 mm.

Each radially inner 24 and radially outer 26 working layer has an axial width T1=224 mm and T2=210.00 mm, respectively.

Note that, as in the first embodiment, SW=255 and T2=210 mm satisfy the following relations T2≥SW−75, preferably T2≥SW−70 and T2≤SW−27, preferably T2≤SW−30 and that the ratio T2/A is such that 0.85≤T2/A≤1.00, preferably 0.90≤T2/A≤1.00, and more preferentially 0.93≤T2/A≤0.97 and in this case T2/A=0.97.

Unlike the first embodiment, the tyre 11 of the second embodiment comprises first and second carcass layers 36, 37 delimited axially by two axial edges 361, 362, 371, 372, respectively, and comprising textile carcass filamentary reinforcing elements 360, 370, respectively, extending axially from one axial edge 361, 371 to the other axial edge 362, 372 in a main direction D3 forming an angle AC which, in terms of absolute value, ranges from 80° to 90° with the circumferential direction X of the tyre 10; in this case AC=+90°.

Each first and second carcass layer 36, 37 extends in each sidewall 30 and in the crown 12 radially on the inside of the crown reinforcement 16.

The first carcass layer 36 forms a winding around each circumferential reinforcing element 33 of each bead 32 such that an axially inner portion 3611, 3621 of the first carcass layer 36 is arranged axially on the inside of an axially outer portion 3612, 3622 of the first carcass layer 36 and such that each axial end 361, 362 of the first carcass layer 36 is arranged radially on the outside of each circumferential reinforcing element 33. Each axial end 371, 372 of the second carcass layer 37 is arranged radially on the inside of each axial end of the first layer 361, 362 and is arranged axially between the axially inner and outer portions 3611, 3612 and 3621, 3622 of the first carcass layer 36.

Each axial end 361, 362 of the first carcass layer 36 is arranged radially on the inside of the equator E of the tyre. More specifically, each axial end 361, 362 of the first carcass layer 36 is arranged at a radial distance RNC of less than or equal to 30 mm from a radially outer end 331 of each circumferential reinforcing element 33 of each bead 32. In this case, RNC=23 mm.

Each textile carcass filamentary reinforcing element 360, 370 of each first and second carcass layer 36, 37 comprises an assembly of at least two multifilament plies 363, 364, 373, 374. In this case, each assembly is made up of two PET multifilament plies, these two multifilament plies being twisted in a helix individually at 420 turns per meter in one direction and then twisted together in a helix at 420 turns per meter in the opposite direction. Each of these multifilament plies has a count equal to 144 tex such that the total count of the assembly is less than or equal to 475 tex and in this case equal to 288 tex.

Each textile carcass filamentary reinforcing element 360, 370 has an average diameter D1, D2, respectively, expressed in mm, such that D1≤0.90 mm and D2≤0.90 mm, preferably D1≤0.85 mm and D2≤0.85 mm and more preferentially D1≤0.75 mm and D2≤0.75 mm and such that D1≥0.55 mm and D2≥0.55 mm, preferably D1≥0.60 mm and D2≥0.60 mm. In this case, D1=D2=0.62 mm.

Comparative Tests

Static Test

FIG. 6 shows the result of a static crushing test on a tyre of size 205/40R17 similar to the first embodiment but in which the ratio T2/A is equal to 1.01 (tyre shown on the left hand side, in which working layers with T1=180 mm and T2=180 mm were used) and the tyre according to the first embodiment, the ratio T2/A of which is equal to 0.93 (tyre shown on the right hand side). The load applied to each tyre is equal to 560 kg at a pressure of 250 kPa.

It can be seen that the deflection of the left-hand tyre is much greater than the deflection of the right-hand tyre. To be specific, the distance DR1 from the axis of rotation R to the ground in the left-hand tyre is less than the distance DR2 from the axis of rotation R to the ground in the right-hand tyre.

Note in particular that the sidewalls of the right-hand tyre are radially straighter than the sidewalls of the left-hand tyre. This can be seen by comparing, at the same radial point on each sidewall, the distances DF1 and DF2 between the outer surface of the sidewall located on the opposite side to the contact patch and the plane SA perpendicular to the axis of rotation R of the tyre and passing through the bearing face of the rim delimiting the axial width A of the rim. This can also be seen by comparing, at the same radial point on each sidewall located alongside the contact patch, the distances DF1′ and DF2′ between the outer surface of the sidewall and the perpendicular plane SA. It is observed that DF1>DF2 and that DF1>DF2′.

Running Test Simulations

The inventors simulated the running of the tyres according to the first and second embodiments of the invention mounted on different rims, including the rim having a rim width code equal to the measuring rim width code for the tyre size minus 0.5, in this case 7 for the tyre according to the first embodiment and 8.5 for the tyre according to the second embodiment. The running of the tyres according to the first and second embodiments of the invention was also simulated on rims not recommended by the ETRTO 2019 Standards Manual for the purposes of demonstrating and understanding the technical effect of the invention (rims with a rim width code of 6.5 and 8, respectively).

For each mounted assembly, a simulation of a running test similar to the load/speed performance test described in Annex VII of UNECE Regulation No 30 was carried out, but under even more demanding conditions.

During these simulations, the maximum volumic energy dissipation DNRJ of the calendering matrix was recorded in a portion of the single carcass layer for the tyre according to the first embodiment and in a portion of the second carcass layer for the tyre according to the second embodiment, located in the sidewall, and expressed in daN/mm2. The higher this value, the greater the energy dissipation by the tyre structure and the greater the rise in temperature.

These values were expressed in relation to a relative value 100 below which the energy dissipation is controlled for the size tested and above which the energy dissipation is not sufficiently controlled. This relative value 100 is different for each size tested.

The gain in exterior bulk of the vehicle with respect to the measuring rim was also calculated. A negative gain corresponds to an increase in the exterior bulk of the vehicle. For a given rim, a gain in exterior bulk of the vehicle is necessarily accompanied by a reduction in the mass of the rim and therefore a reduction in the masses in rotation on the vehicle.

These values were collated in tables 1 and 2 below for each first and second embodiment, respectively.

TABLE 1

| A (inches) | Gain (cm) | T2/A | DNRJ (Base 100) |
|---|---|---|---|
| 6.5 | 5.08 | 1.01 | 117 |
| 7 | 2.54 | 0.93 | 60 |
| 7.5 | 0 | 0.87 | 37 |
| 8 | −2.54 | 0.82 | 43 |

TABLE 2

| A (inches) | Gain (cm) | T2/A | DNRJ (Base 100) |
|---|---|---|---|
| 8 | 5.08 | 1.03 | 120 |
| 8.5 | 2.54 | 0.97 | 73 |
| 9 | 0 | 0.92 | 47 |
| 9.5 | −2.54 | 0.87 | 53 |

These tests show that the reduction in the ratio T/2A makes it possible to control the dissipation of energy in the portion of the carcass reinforcement located in the sidewall, even under a relatively heavy load and with a pressure lower than the pressure recommended for carrying the corresponding load.

Thus, in order, on the one hand, to control this energy dissipation and, on the other hand, to limit the increase in the masses in rotation on the vehicle but also the size of the mounted assembly to the benefit of roominess and compactness of the vehicle, the best compromise is obtained by limiting the axial width T2 and using a rim having a rim width code equal to the measuring rim width code for the tyre size, defined according to the ETRTO 2019 Standards Manual, minus 0.5 such that the ratio T2/A is less than or equal to 1.00.

The invention is not limited to the embodiments described above.

1.-13. (canceled)

14. A tire (11) for a passenger vehicle comprising a crown (12), two beads (32), two sidewalls (30) each connecting each bead (32) to the crown (12), and a carcass reinforcement (34) anchored in each bead (32), the crown (12) comprising a crown reinforcement (16) and a tread (14), the carcass reinforcement (34) extending in each sidewall (30) and in the crown (12) radially internally to the crown reinforcement (16), the crown reinforcement (16) being arranged radially between the tread (14) and the carcass reinforcement (34) and comprising a working reinforcement (20) comprising at least an axially narrowest working layer (26), the axially narrowest working layer (26) having an axial width T2 expressed in mm, the tire (11) being adapted to be mounted on a mounting support (100) comprising a rim (200),
wherein the tire (11) has a load index L1 such that LI≥LI′+1, with LI′ being a load index of an EXTRA LOAD tire of a same size according to standard ETRTO 2019, and
wherein, when the tire is mounted on a rim having a rim width code equal to a measuring rim width code for a tire size defined according to standard ETRTO 2019 minus 0.5, a ratio T2/A is such that T2/A≤1.00 with A being a rim width A according to standard ETRTO 2019, expressed in mm of the rim.

15. The tire according to claim 14, wherein LI′+1≤LI≤LI′+4.

16. The tire according to claim 14, wherein 0.85≤T2/A.

17. The tire according to claim 14, wherein the tire (11) has a nominal section width SW such that T2≥SW−75 and T2≤SW−27.

18. The tire according to claim 14, wherein the tire (11) has a nominal section width SW ranging from 205 to 315, a nominal aspect ratio ranging from 25 to 55, a nominal rim diameter ranging from 17 to 23 and the load index LI ranging from 98 to 116.

19. The tire according to claim 14, wherein 0.82≤H/LI≤0.98, H being a sidewall height defined by H=SW×AR/100, where SW is a nominal section width and AR is a nominal aspect ratio of the tire.

20. The tire according to claim 14, wherein the tire (11) has a size and the load index LI selected from the following sizes and load indexes: 225/55R18 105, 225/55ZR18 105, 205/55R19 100, 205/55ZR19 100, 235/45R21 104, 235/45ZR21 104, 285/45R22 116, 285/45ZR22 116, 205/40R17 88, 205/40ZR17 88, 245/40R19 101, 245/40ZR19 101, 255/40R20 104, 255/40ZR20 104, 245/40R21 103, 245/40ZR21 103, 255/40R21 105, 255/40ZR21 105, 265/40R21 108, 265/40ZR21 108, 255/40R22 106, 255/40ZR22 106, 255/35R18 98, 255/35ZR18 98, 245/35R20 98, 245/35ZR20 98, 265/35R20 102, 265/35ZR20 102, 245/35R21 99, 245/35ZR21 99, 255/35R21 101, 255/35ZR21 101, 265/35R21 103, 265/35ZR21 103, 275/35R21 105, 275/35ZR21 105, 285/35R21 108, 285/35ZR21 108, 295/35R22 111, 295/35ZR22 111, 275/35R23 108, 275/35ZR23 108, 285/30R21 103, 285/30ZR21 103, 315/30R21 109, 315/30ZR21 109, 325/30R21 111, 325/30ZR21 111, 315/30R23 111, and 315/30ZR23 111.

21. The tire (11) according to claim 14, wherein the tire (11) is inflated to a pressure ranging from 200 to 350 kPa.

22. The tire (11) according to claim 14, wherein the working reinforcement (20) comprises a radially inner working layer (24) and a radially outer working layer (26) arranged radially on an outside of the radially inner working layer (24).

23. The tire (11) according to claim 14, wherein the axially narrowest working layer (26) or each working layer (24, 26) is delimited axially by two axial edges (241, 242, 261, 262) of the working layer (24, 26) and comprises working filamentary reinforcing elements extending axially from one axial edge to an other axial edge of the working layer (24, 26) substantially parallel to one another.

24. The tire (11) according to claim 23, wherein each working filamentary reinforcing element extends in a main direction forming an angle which, in terms of absolute value, is strictly greater than 10° with a circumferential direction (X) of the tire (11).

25. The tire (11) according to claim 14, wherein the carcass reinforcement (34) comprises at least one carcass layer (36, 37), the or each carcass layer (36, 37) being delimited axially by two axial edges (361, 362, 371, 372) of the or each carcass layer (36, 37) and comprises textile carcass filamentary reinforcing elements (360, 370) extending axially from one axial edge to an other axial edge of the or each carcass layer (36, 37) in a main direction forming an angle which, in terms of absolute value, ranges from 80° to 90°, with a circumferential direction (X) of the tire (11).

26. The tire (11) according to claim 14, wherein the carcass reinforcement comprises a single carcass layer, the tire having a sidewall height H defined by H=SW×AR/100 with SW being a nominal section width and AR a nominal aspect ratio of the tire and such that H<95 and that 0.82≤H/LI≤0.92.

27. The tire (11) according to claim 26, wherein the single carcass layer forms a winding around a circumferential reinforcing element of each bead such that an axially inner portion of the single carcass layer is arranged axially on an inside of an axially outer portion of the single carcass layer and such that each axial end of the single carcass layer is arranged radially on an outside of each circumferential reinforcing element.

28. The tire (11) according to claim 26, wherein the single carcass layer has a portion arranged axially between two circumferential reinforcing elements of each bead and each axial end of the single carcass layer is arranged radially on an inside of each radially outer end of each circumferential reinforcing element of each bead.

29. The tire (11) according to claim 14, wherein the carcass reinforcement comprises first and second carcass layers, the tire having a sidewall height H defined by H=SW×AR/100 with SW being a nominal section width and AR a nominal aspect ratio of the tire and such that H≥95 and that 0.88≤H/LI≤0.98.

30. The tire (11) according to claim 14, wherein the crown reinforcement (16) comprises a hoop reinforcement (22) delimited axially by two axial edges (281, 282) of the hoop reinforcement and comprising at least one hooping filamentary reinforcing element wound circumferentially in a helix so as to extend axially between the axial edges (281, 282) of the hoop reinforcement (22).
